(19) United States
(12) Patent Application Publication
(10) Pub. No.: US 2004/0168093 A1
(43) Pub. Date: Aug. 26, 2004

(54) Remote controlling method

(75) Inventor: Tzu Hsiang Yen, Chung-Ho City (TW)

Correspondence Address: BACON & THOMAS, PLLC, 625 SLATERS LANE, FOURTH FLOOR, ALEXANDRIA, VA, 22314

(73) Assignee: CHIC TECHNOLOGY CORP., Chung-Ho City (TW)

(21) Appl. No.: 10/372,273

(22) Filed: Feb. 25, 2003

(51) Int. Cl. G06F 1/26

(52) U.S. Cl. 713/300

(57) ABSTRACT

The present invention relates to a remote controlling method wherein the terminal appliance passes through Web to connect to LAN to further pass through telephone wire, coaxial cable, Cat 5 to connect to Internet for remote controlling. The present invention mainly consists of Web control, controller and RJ-45 support. The Web control is characterized by the use of Embedded Web Power for embedded Web management and provides human browser operating interface for easy installation and controlling. The controller consists of a built-in Embedded Web Power designed with serial port holes connecting the terminal machine (or terminal simulator) to Embedded Web Power and using service list provided by the built-in controller for setting up of IP address and wave frequency. The RJ-45 support provides a RJ-45 entry to enable remote access to terminal controller procedure. The present invention therefore provides an independent, complete control of the terminal device power of Internet system to prevent any web or appliance damage or threat due to a break through in wave frequency.

### TECHNICAL RANGE

The present invention relates to a remote controlling method especially one wherein the terminal appliance passes through Web to connect to LAN(Local Area Network) to further pass through telephone wire, coaxial cable, Cat 5 (Category 5) to connect to Internet for remote controlling.

### INVENTION BACKGROUND

Following popular use of personal computers and increasing power of link network, the development of Internet is becoming more and more mature and the development of LAN(Local Area Network), MAN(Metropolitan Area Network) has reach a considerable extent and coaxial cable, Cat 5 have formed FTTC, FTTB and FTTH (three kinds of metro optical network)Internet structures through main city channels. The use of web for remote appliance control are becoming the trend of development and the use of modem in telephone wires

ASDL/VDSL(Asymmetric Digital Subscriber LoopNery High Data Rate DSL) has made it possible. The terminal appliance passes through Web to connect to LAN to further pass through telephone wire, coaxial cable, Cat 5 to connect to Internet for remote controlling.

However, in practical life, several factors can cause accidental damage to the terminal appliance mentioned above: infrequent waves induced by magnetic force, static electricity, ground wire, switch action, radar sensing or direct lightning electrocution and so on resulting in severe data and information loss of web appliances. Since infrequent waves mainly cause circuit damage followed by continuous web and appliance damage, it is therefore important to proceed to web power central management and protection.

### SUMMARY OF INVENTION

The present invention relates to a remote controlling method using a special Internet power controlling system for remote management passing through Embedded Web Power to allow user to connect to the terminal appliance power (PC, SERVER, LAN SWITCH, ROUTER, GATEWAY and so on . . . ) of the Internet for complete independent control. Up to now, regardless of business news equipment or industrial automatic system, any infrequent wave or accident will cause a disconnection of the system leading to serious information damage and a great loss to the company as well as the client. In order to avoid such a possible accident, the user has only to connect the above-mentioned appliance power to Embedded Web Power passing through Embedded Web Power built-in Internet connecting function for easy control of long-distance machine control and thus decreasing damage and loss of time caused by disconnection of system. In addition, special attention should be paid to safe and reliable process of appliance power system in connection to distant microwave station, mobile communication base and mechanical communication cabins. Hence, an Embedded Web Power can be installed in local web managing center for distant control of appliance cabins thus decreasing man-energy and loss of time.

### DESCRIPTION OF DRAWINGS

FIG. 1 shows a plan of a simple residential network control.

### NUMERICALS

10—web cable 20—power cable

30—residence 31—house equipment

32—network control 33—network remote-end

34—infrequent wave protection and power control

35—Embedded Web Power 36—PC

### MODE FOR CARRYING OUT INVENTION

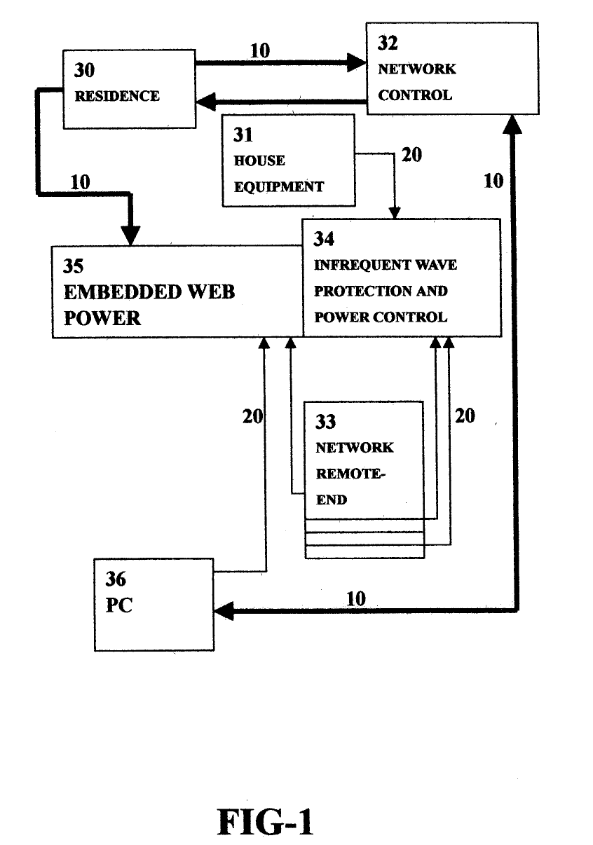

With reference to FIG. 1 showing a plan of a simple home residential network control, the web cable 10 is represented by the thick line and the power cable 20 by the thin line. Following the development of technology, more and more residences 30 are considering modern intelligent appliances (LAN family residence built-in family web), and more and more house equipment 31 need network control 32 and distant supervising [using Internet connecting method LAN(Local Area Network), WAN(Wide Area Network), MAN(Metropolitan Area Network) such as: telephone wire, cable TV, fiber for distant controlling and news interchange]. Every house equipment 31 and network remote-end 33 (PC, SERVER, LAN, SWITCH, ROUTER, GATEWAY . . . ) all need infrequent wave protection and power control 34. The Embedded Web Power 35 provided by the present invention allows the user to understand house equipment 31 and network remote-end 33 functioning status through PC 36 when being away such that he can use Embedded Web Power 35 to handle any break down or unusual status of house equipment.

### INVENTION TECHNIQUES

The above-mentioned Embedded Web Power is characterized by the following techniques:

The supervising motherboard or PC is directly connected to LAN to easily supervise or switch control of distant power;

One RJ-11;

One RJ-45;

Several 10A/250 VAC 3-phase power plug output Ability to reset IP(Internet Protocol) address and wave frequency (RJ-11);

Standard TCP(Transmission Control Protocol), IP(Internet Protocol), TELNET(Telephone Network), DHCP(Dynamic Host Configuration Protocol), HTTP(Hypertext Transfer Protocol), ICMP(Internet Control Message Protocol);

Web monitor, managing power plug status; and,

Including infrequent wave protection.

### INVENTION METHOD

The above-mentioned Embedded Web Power controlling method provided by the present invention is characterized as below:

Web control: Embedded Web Power is characterized by embedded Web management providing human browser operating interface for easy installation and control;

Controller: the Embedded Web Power is designed with serial port holes connecting terminal machine (or terminal simulator) to Embedded Web Power and using service list provided by built-in controller for setting up of IP address and wave frequency; and,

RJ-45 support: the Embedded Web Power provides a RJ-45 entry to enable remote access to terminal controller procedure.

### POWER SOURCE AND ENVIRONMENT

The present invention mentioned above of an Embedded Web Power characterized by the following power source and environment:

Highest output voltage: 10A (220 VAC);

Working voltage: 90˜260 VAC;

Power frequency: 50˜60 HZ;

Working temperature: 0˜40° (celsius);

Storage temperature −15˜55° (celsius); and

Relative humidity: 5˜95%.

### REASON OF INVENTION

The purpose of the above-mentioned invention using Embedded IP skill passing through RJ-45 for remote controlling is to carry on inspection, distant maintenance and re-starting function of Web equipment in case of accidental damage or unusual working conditions. Hence, the RJ-45 entry designed in the Embedded Web Power plays a very important role in increasing reliability, safety and distant protection of server, remote-end, internet, switch power and router.

1. A “Remote controlling method” mainly consisting of Web control, controller and RJ-45 support, wherein:
Said Web control is characterized by use of Embedded Web Power for use of embedded Web management to provide a human browser operating interface for easy installation and controlling;
Said controller consists of a built-in Embedded Web Power designed with serial port holes connecting the terminal machine (or terminal simulator) to Embedded Web Power and using service list provided by built-in controller for setting up of IP address and wave frequency;
Said RJ-45 support provides a RJ-45 entry to enable remote access to terminal controlling procedure, as characterized.

2. As mentioned in claim 1 of a “Remote controlling method”, the techniques of Embedded Web Power include:
The supervising motherboard or PC is directly connected to LAN to easily supervise or switch control of distant power;
One RJ-11;
One RJ-45;
Several 10A/250 VAC 3-phase power plug output;
Ability to reset IP address and wave frequency (RJ-11);
Standard TCP(Transmission Control Protocol), IP(Internet Protocol), TELNET(Telephone Network), DHCP(Dynamic Host Configuration Protocol), HTTP(Hypertext Transfer Protocol ), ICMP(Internet Control Message Protocol);
Web monitor, managing power plug status, and, Including infrequent wave protection.

3. As mentioned in claim 1 of a “Remote controlling method”, wherein the Embedded Web Power is characterized by the following power source and environment:
Highest output voltage: 10 A (220 VAC);
Working voltage: 90˜260 VAC;
Power frequency: 50˜60 HZ;
Working temperature: 0˜40° (Celsius);
Storage temperature: −15˜55° (Celsius); and,
Relative humidity: 5˜95%.
